(19) United States
(12) Patent Application Publication
(10) Pub. No.: US 2020/0060251 A1
(43) Pub. Date: Feb. 27, 2020

(54) DEVICE FOR REDUCING MALARIA AND OTHER MOSQUITO TRANSMITTED DISEASES

(71) Applicants: Rodrigo R. DaSilva, Waterbury, CT (US); Nana Banafo, Santa Clara, CA (US)

(72) Inventors: Rodrigo R. DaSilva, Waterbury, CT (US); Nana Banafo, Santa Clara, CA (US)

(21) Appl. No.: 16/532,642

(22) Filed: Aug. 6, 2019

Related U.S. Application Data
(60) Provisional application No. 62/722,750, filed on Aug. 24, 2018.

(51) Int. Cl. A01M 1/02; A01M 1/04; A23K 50/90

(52) U.S. Cl. CPC A01M 1/023; A01M 2200/012; A23K 50/90; A01M 1/04

(57) ABSTRACT

A device and method for reducing cases of mosquito transmitted diseases in humans including an inner member containing a food source causing sterilization of female mosquitoes, an outer housing positioned over the inner member and having at least one opening and an attractant within the outer housing to attract mosquitoes to the food source.

This application claims priority from provisional application Ser. No. 62/722,570, filed Aug. 24, 2018, the entire contents of which incorporated herein by reference.

### BACKGROUND

### Field of the Invention

This application relates to a device for reducing transmission of mosquito transmitted diseases, and more particularly, to a device that attracts and sterilizes female mosquitoes to reduce mosquito transmitted diseases such as malaria.

### Background

Malaria is a serious and sometimes fatal disease caused by a microscopic parasite that commonly infects a certain type of mosquito which is transmitted to humans through bites of the infected mosquitoes. The mosquito bites and infects the person, which infects the liver and infects the red blood cells. When a mosquito bites an infected person, the mosquito becomes infected, and when it bites another person, that person becomes infected and thus the disease spreads. The mosquito transmission cycle can be summarized as follows:
a) Uninfected mosquito—a mosquito becomes infected by feeding on a person who has malaria.
b) Transmission of parasite—if this infected mosquito bites a person in the future, it can transmit malaria parasites to that person.
c) In the liver—once the parasites enter the human body, they travel to the liver where some types can lie dormant for as long as a year.
d) Into the bloodstream—when the parasites mature, they leave the liver and infect the red blood cells. This is when people typically develop malaria symptoms.
e) On to the next person—if an uninfected mosquito bites a person at this point in the cycle, it will become infected with malaria parasites from that person and can spread them to the other people it bites.

Other modes of transmission of malaria are through infected blood. Since the parasites that cause malaria affect red blood cells, people can also get malaria from exposure to infected blood, including: from mother to unborn child, through blood transfusions or by sharing needles used to inject drugs.

People who get malaria typically get very sick with high fevers, shaking chills, and flu-like illness. In some cases, malaria can cause death as a result of serious life threatening complications such as a) cerebral malaria wherein parasite-filled blood cells block small blood vessels to the brain, causing swelling of the brain, brain damage seizures and/or coma; b) breathing problems due to accumulated fluid in the lungs (pulmonary edema) making it difficult to breathe; c) organ failure causing kidneys or liver to fail, or spleen to rupture; d) anemia wherein malaria damages red blood cells; and/or e) low blood sugar (hypoglycemia), which can result in coma or death. Some varieties of the malaria parasite, which typically cause milder forms of the disease, can persist for years and cause relapses.

There are many different varieties of malaria parasites, and this creates an increased challenge for developing medicines or a vaccine. The variety that causes the most serious complications is most commonly found in African countries south of the Sahara Desert, the Asian subcontinent, New Guinea, the Dominican Republic and Haiti. Malaria is still common in tropical and subtropical countries. By some estimates, each year, approximately 210 million people are infected with malaria, and about 440,000 people die from the disease. Most of the people who die from the disease are young children in Africa.

One approach to reduce the incidence of malaria is by distributing bed nets to help protect people from mosquito bites as they sleep. Protective clothing (pants and long sleeved shirts) to cover the skin and insect repellant, such as sprays containing DEET for skin and sprays containing permethrin for clothing, applied to the skin and clothing are also used in attempts to prevent the illness. Scientists are working to develop a safe and effective vaccine to prevent malaria, however to date, a vaccine has not yet been approved for human use. Many malaria parasites are now resistant to the most common drugs used to treat the disease.

Widespread spraying of areas can have adverse environmental consequences. Additionally, such spraying is controversial since if not controlled could wipe out the species of mosquitoes.

The World Health Organization (WHO) reports significant progress being made in the fight against malaria as some countries previously with high incidence of malaria have now been certified malaria-Free countries by the WHO. However, despite the optimistic outlook on malaria eradication efforts, malaria continues to be prevalent in Sub-Saharan Africa. In 2016, as reported by the WHO, there were an estimated 216 million cases of malaria in 91 countries with approximately 90% of the recorded deaths from the Sun-Saharan African region. Therefore, much works remains to be done to reduce malaria.

The need exists for an effective way to reduce malaria transmission. Many of the current methods might provide some protection on an individual basis but unfortunately do not address large groups, nor do they attempt to address malaria at the source. Attacking malaria at the source would greatly reduce malaria cases. There are also many other mosquito transmitted illnesses such as dengue fever, encephalitis, etc. Attacking the illness at its source could also provide a way to effectively reduce the cases of these other mosquito transmitted diseases.

### SUMMARY

The device of the present invention advantageously reduces transmission of mosquito transmitted diseases (illnesses) such as malaria. This is achieved by a media contained within a housing that is provided to attract mosquitoes and when attracted and bit, it sterilizes the eggs of the female mosquitoes, thereby reducing without eliminating the population of malaria-carrying mosquitoes. The versatility of device enables portability in some embodiments as well as safe indoor and outdoor use. Various embodiments of the device and its method of use are described in detail below.

In accordance with one aspect of the present invention, a device for reducing cases of mosquito transmitted diseases, such as malaria, in humans is provided comprising an inner member containing a food source causing sterilization of female mosquitoes, an outer housing receiving the inner member having at least one opening, and an attractant within the outer housing to attract mosquitoes to the food source.

In some embodiments, the opening in the outer housing is dimensioned for entry of mosquitoes to access the food source contained by the inner member. In some embodiments, the food source is contained in a membrane which protrudes through the at least one opening for mosquitoes to access. A plunger can be provided to effect such protrusion.

In some embodiments, the inner member is removable and replaceable with another inner member having a food source. In some embodiments, the inner member contains at least one panel containing individual pods arranged in an array, the pods providing the food source. In some embodiments, the inner member comprises a self-sealing hydrogel membrane positioned over the food source.

The inner member and/or housing in some embodiments is transparent so a level of food source contained within the inner member can be checked.

In some embodiments, a light source is positioned within the outer housing to warm the food source. The light source can also be used as an attractant for mosquitoes.

In some embodiments, the attractant emits an odor to attract mosquitoes and contains CO2 and sulfur.

In some embodiments, the food source is synthetic blood designed to mimic the physical and chemical properties of blood including color and viscosity.

In accordance with another aspect of the present invention, a device for reducing cases of mosquito transmitted diseases, such as malaria, is provided comprising a support and a synthetic blood media supported by the support, the synthetic blood media providing a nutrition source to sterilize female mosquitoes. Preferably, the synthetic blood media satiates the female mosquitoes.

In some embodiments, the support comprises a self-sealing hydrogel membrane covering the synthetic blood media therein. In some embodiments, the hydrogel membrane is removably mounted to the support and replaceable with another hydrogel membrane covering a synthetic blood media. The device in some embodiments includes an outer housing wherein the support is contained within the outer housing and the outer housing has at least one opening dimensioned to restrict access to the synthetic blood media by vertebrates. In some embodiments, the hydrogel membrane protrudes through the at least one opening in the outer housing.

The device preferably comprises an attractant to attract the mosquitoes. In some embodiments, the attractant is an odor generator containing CO2 and sulfur.

In accordance with another aspect of the present invention, a device for reducing cases of mosquito transmitted illnesses, such as malaria, in humans is provided comprising a food source causing sterilization of female mosquitoes and a housing containing the food source having at least one opening dimensioned for entry of mosquitoes to access the food source within the housing. The housing includes a fluid entry port for insertion of the food source within the housing. An attractant within the housing attracts mosquitoes to the food source.

In some embodiments, the attractant is an odor generator containing CO2 and sulfur. Preferably, a level of the food source within the housing is visible.

In accordance with another aspect of the present invention, a device is provided for reducing cases of mosquito transmitted illnesses in humans comprising a food source causing sterilization of female mosquitoes, the food source being a synthetic blood media. A membrane covers the synthetic blood. The food source is positioned within the housing, the housing having at least one opening dimensioned for entry of mosquitoes to access the food source. The housing includes a cover removably mounted to the housing, the cover enabling removal and replacement of the food source.

In some embodiments, an attractant is provided within the device to attract mosquitoes to the food source.

In some embodiments, the membrane is a hydrogel membrane supporting at least one pod of synthetic blood media.

In some embodiments, the membrane is a hydrogel membrane and the membrane is attached to the front cover wherein removal of the front cover removes the food source and the food source is replaced by a second front cover with a hydrogel membrane and food source attached.

In some embodiments, the hydrogel membrane protrudes through the at least one opening in the outer housing A plunger can be provided to effect such protrusion.

In accordance with another aspect of the present invention, a device is provided for changing a diet of mosquitoes to reduce a portion of a population of the mosquitoes to reduce cases of mosquito transmitted illnesses. The device comprises a synthetic blood media supported within a housing, the synthetic blood media providing a food source to reduce egg proliferation of female mosquitoes. The device preferably includes an attractant within the housing, which can contain CO2 and sulfur, to attract mosquitoes to the food source.

In some embodiments, the food source provides the mosquitoes with a satiated feeling to reduce feeding.

In some embodiments, the device is portable and is safe for indoor use; in other embodiments, the device is safe and configured for outdoor use.

In some embodiments, the housing has openings dimensioned to enable access to the synthetic blood media by the female mosquitoes but restrict access to the synthetic blood media by vertebrates.

In some embodiments, the food source is covered by a self-sealing hydrogel membrane.

The devices can be used to reduce the cases of mosquito vector borne illnesses such as malaria, dengue fever, Zika virus, Chikungunya, Yellow Fever, Eastern Equine Encephalitis, St. Louis Encephalitis, LaCrosse Encephalitis, Western Equine Encephalitis, and/or West Nile Virus.

In accordance with another aspect of the present invention, a disease control device is provided having direct reduction potential on mosquito transmitted disease comprising a housing and an internal chamber containing a food source which interrupts proliferation of viable eggs of female mosquitoes feeding on the food source. The food source, in preferred embodiments, is a synthetic food source and provides the mosquitoes a satiated feeling to reduce likelihood of biting. In preferred embodiments, the device includes an attractant, such as an odor generator, to attract mosquitoes to the food source.

In some embodiments, the food source is covered by a penetrable self-sealing hydrogel membrane. The hydrogel membrane and food source, in some embodiments, are replaceable with another hydrogel membrane and food source.

In some embodiments, the internal chamber containing the food source is transparent to visualize a fluid level. The device can include a light source to warm the food source. The light can also in some embodiments serve as a mosquito attractant.

In some embodiments, the food source mimics blood type constituents.

In accordance with another aspect of the present invention, a method is provided for reducing a portion of a population of the mosquitoes to reduce cases of mosquito transmitted illnesses. The method comprises providing a synthetic blood media supported within a housing and a mosquito attractant, the synthetic blood media providing a food source to reduce egg proliferation of female mosquitoes feeding on the synthetic media.

The synthetic blood media in some embodiments is of a composition that provides the mosquitoes with a satiated feeling to reduce additional feedings. In some embodiments, the synthetic blood media is partially or fully covered by a hydrogel membrane, wherein the hydrogel membrane is self-sealing as mosquitoes bite through to access the synthetic blood media.

The method can be used to reduce the cases of mosquito vector borne illnesses such as malaria, dengue fever, Zika virus, Chikungunya, Yellow Fever, Eastern Equine Encephalitis, St. Louis Encephalitis, LaCrosse Encephalitis, Western Equine Encephalitis, and/or West Nile Virus.

### BRIEF DESCRIPTION OF THE DRAWINGS

So that those having ordinary skill in the art to which the subject invention appertains will more readily understand how to make and use the surgical apparatus disclosed herein, preferred embodiments thereof will be described in detail hereinbelow with reference to the drawings, wherein:

FIGS. 1A-1F illustrate a first embodiment of the malaria reducing device of the present invention wherein;

FIG. 1A is a perspective view of the internal cartridge;

FIG. 1B is a perspective view of the internal cartridge positioned within an outer housing;

FIG. 1C is a perspective view showing the housing prior to placement over the internal cartridge to encapsulate the internal cartridge;

FIG. 1D is a top view of the internal cartridge;

FIG. 1E is a cutaway front view of the fully assembled device;

FIG. 1F is a front view of the fully assembled device;

FIGS. 2A-2D illustrate an alternate embodiment of the malaria reducing device of the present invention wherein:

FIG. 2A is a perspective view of the internal cartridge;

FIG. 2B is an exploded view of the holding fixture and base, prior to assembly, for supporting the cartridge;

FIG. 2C is a perspective view of the internal cartridge being slid into the holding fixture;

FIG. 2D is a front view of the assembled device showing the cartridge supported by the holding fixture; and

FIG. 2E is a front view of the fully assembled device;

FIGS. 3A-3G show another alternate embodiment of the malaria reducing device of the present invention wherein:

FIG. 3A is an exploded view of the device;

FIG. 3B is a perspective view of the assembled device with the internal cartridge within the outer housing and the top cover attached to the outer housing;

FIG. 3C is a top view of the device with the top cover removed;

FIG. 3D is a front view of the device;

FIG. 3E is a perspective view of the device;

FIG. 3F is a perspective view of the device partially assembled showing the internal cartridge almost fully inserted into the outer housing and the top cover removed; and

FIG. 3G is a front view of the device;

FIGS. 4A and 4B are perspective views of an alternate embodiment of the malaria reducing device of the present invention having a fluid filling port;

FIG. 5A is a perspective view of an alternate embodiment of the malaria reducing device of the present invention configured for table top placement;

FIG. 5B is a perspective view of the device of FIG. 5A showing the internal cartridge prior to insertion into the outer housing;

FIG. 6 is a schematic view of the features of the pole version of malaria reducing device of the present invention;

FIGS. 7A-7E show another alternate embodiment of the malaria reducing device of the present invention wherein:

FIG. 7A is a perspective view of the device;

FIG. 7B is a perspective view of the front cover of the device;

FIG. 7C is an exploded view of the cartridge containing the food source;

FIG. 7D is a cutaway view of the cartridge; and

FIG. 7E is a perspective view showing the cartridge inserted into the device;

FIG. 8A is a perspective view of an alternate embodiment of the malaria reducing device of the present invention;

FIG. 8B is a perspective view of the device of FIG. 8A showing the font cover with the attached membrane and food source detached from the housing.

FIG. 9A is a perspective view of an alternate embodiment of the malaria reducing device of the present invention; and

FIG. 9B is an exploded view of the device of FIG. 9A; and

FIG. 9C is a cutaway view of the device of FIG. 9A.

### DETAILED DESCRIPTION OF PREFERRED EMBODIMENTS

The device of the present invention is designed to reduce the number of malaria cases and thereby reduce the number of illnesses and deaths from malaria. The device is a malaria vector control device/apparatus with direct reduction potential on mosquito disease transmission comprising a mechanical housing that contains a nutrition source for mosquitoes covered by a membrane and contains attractants to the nutrition source. The device attracts mosquitoes to the synthetic food (nutrition) source by a combination of one or more of odor, sound, color and light. The membrane, which in some embodiments is a synthetic skin membrane, attracts mosquitoes and is easy for mosquitos to “drill.” Thus, the device of the present invention reduces the incidents of malaria by attacking the source of malaria transmission—the mosquitoes. The devices of the present invention are not limited to malaria control but also can be used instead of or in addition to reduce incidences of other mosquito transmitted diseases such as by way of dengue fever, Zika virus, Chikungunya, Yellow Fever, Eastern Equine Encephalitis, St. Louis Encephalitis, LaCrosse Encephalitis, Western Equine Encephalitis, and/or West Nile Virus.

The media (nutrition source or food source) is preferably a synthetic or similar composition that will contain synthetic “blood” or media like liquid to mimic blood, i.e., mimic the chemical and physical properties of blood such as for example color and viscosity. The synthetic blood can be dyed either red or lightly colored (opaque/neutral). That is, the synthetic blood media provides a nutrition source designed to simulate human blood. It has several features and functions. It functions as a sterilizer to interrupt egg proliferation—interrupts vector proliferation causing non-viable eggs. By mimicking blood, mosquitoes will be attracted to it and bite it, but due to the composition, this media/blood will make them sterile, thereby reducing the amount of viable eggs they can lay. Thus, once the female mosquitos are contaminated with this “media”, they will not be able to proliferate as before, and a major percentage of their eggs will not survive, thus reducing the mosquito population and reducing malaria.

Additionally, the synthetic blood media composition could also in some embodiments be a satiation bloater preventing multiple feeds. That is, it could make mosquitos feel satiated (full or bloated) and unlikely to feed on the media more than once, thereby conserving the media. Further, by feeling full, the mosquitoes are less likely to bite humans. In other words, the artificial media composition tricks the mosquitoes into feeling full to thereby reduce their biting of humans, dual feeding and/or cross-contamination.

In some embodiments, the synthetic (artificial) blood media is a P. malariae inhibitor, although other media are also contemplated. The synthetic blood media composition causes no harm to humans and contains an inhibitor that causes the mosquitos to produce non-viable eggs and to be less interested in the human blood as the mosquitoes become bloated and feel satiated after feeding. The media in some embodiments is in the form of or contained in separate pods.

In most laboratories, mosquito-rearing diet consists of simple sugars or sugar solutions (household white sugar, corn syrup, honey, various fruit juices, raisins, apple slices). Soaked cotton balls containing approximately 10% sugar is the common and easiest method for providing sugar to adult mosquitoes. Female mosquitoes, however, usually require a blood meal for complete ovarian development. Female mosquitoes are quite selective in distinguishing between blood meals and sugar diet. Therefore, a synthetic blood provides the food source in preferred embodiments.

The combination of the synthetic blood media, the odor, synthetic membrane, and overall accessibility to the food source of the devices disclosed herein provides an attractive device for mosquitoes.

Overlying the media is a membrane designed to simulate human skin conditions/tissue conditions so that mosquitos can be attracted, and able to “drill” in for “blood”. The membrane can be a soft skin material, and can be of varying thicknesses depending on the application. The membrane can be of various materials. In some embodiments the membrane is formed of hydrogel. The membrane in some embodiments covers a portion of the media; in other embodiments the membrane encapsulates the entire media.

The device is designed to attract the mosquitos by smell or sound and will be strategically placed in appropriate locations. Alternatively, or in addition, color or light can be utilized to attract the mosquitoes. The odor generation and composition preferably mimics natural human body odor. The odor preferably contains elements of CO2 and sulfur. A natural source or odor like decorative rocks can be used. Synthetic hormones can also be utilized

The device is some embodiments is a self-standing (free standing) device in the shape of a pole. In other embodiments, it is a self-standing device in the shape of a kerosene lamp. In other embodiments it is in a more horizontal form for placement on a table top. These various shapes are discussed below, and other shapes and sizes are also contemplated. The shapes and sizes, e.g., lengths, can also depend on the location of use of the device, e.g., indoor or outdoor use.

The device is based on the assumption that mosquitoes head upwind only briefly when they encounter just a whiff of carbon dioxide but proceed continuously upwind when the carbon dioxide plume is turbulent, fluctuating in concentration and mimicking the presence of a live host. In some embodiments, the device odor source release frequency can be modified. A mosquito's orientation to human skin odor, in contrast, is optimal when the plume of skin odor is broad and unvarying in its intensity, as would occur when a mosquito closes in on a potential host. Carbon dioxide however induces a faster and more direct upwind orientation than skin odor. In some embodiments, carbon dioxide with trace elements of sulfur can be used for the odor source.

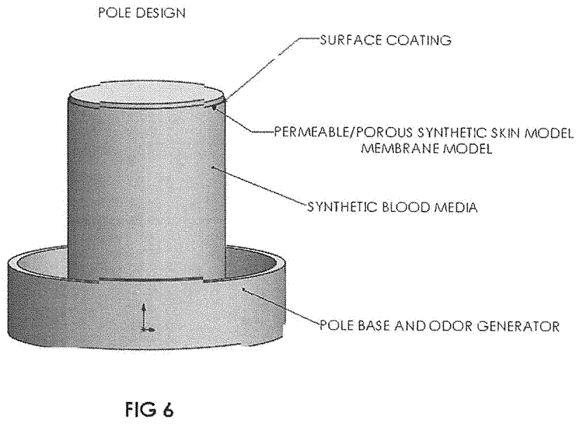

The device in the “pole form” is shown schematically in FIG. 6 and includes a base with the pole extending upwardly from the base. The odor generator is contained in the base. Within the pole is a synthetic blood media extending upwardly from the base which mimics human blood and provides the food source, and a permeable/porous synthetic skin membrane overlying the blood media to simulate human skin. A surface coating can be provided over the synthetic skin.

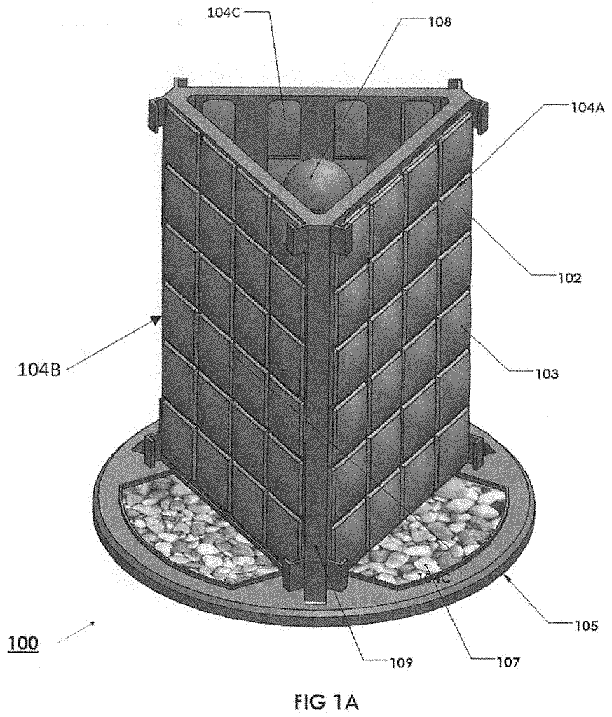

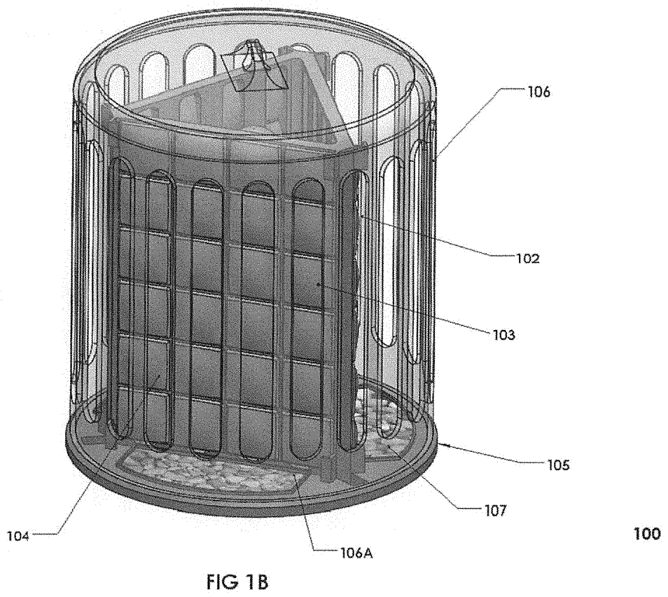

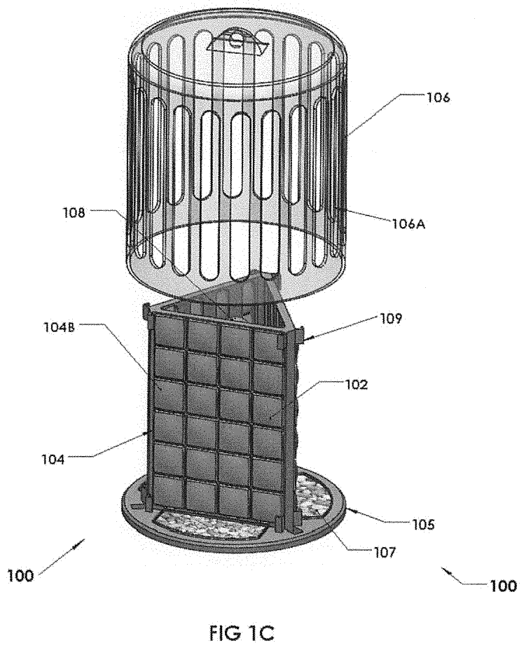

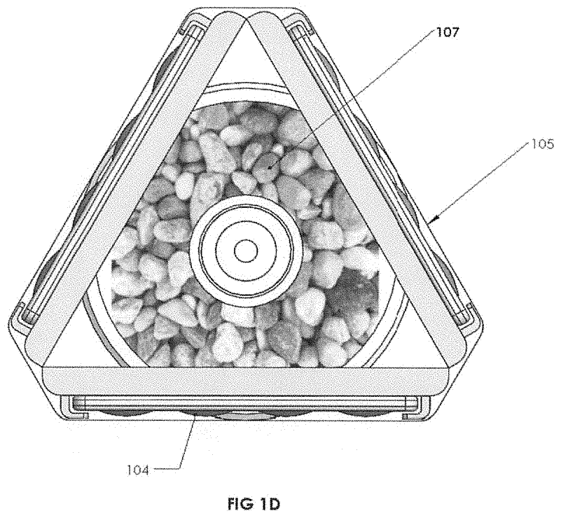

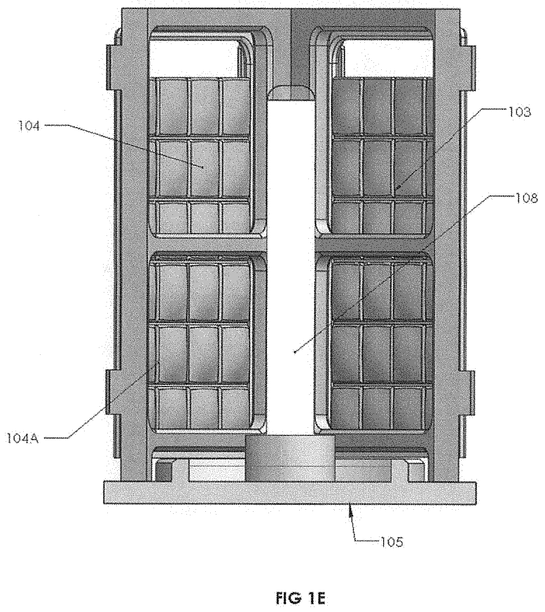

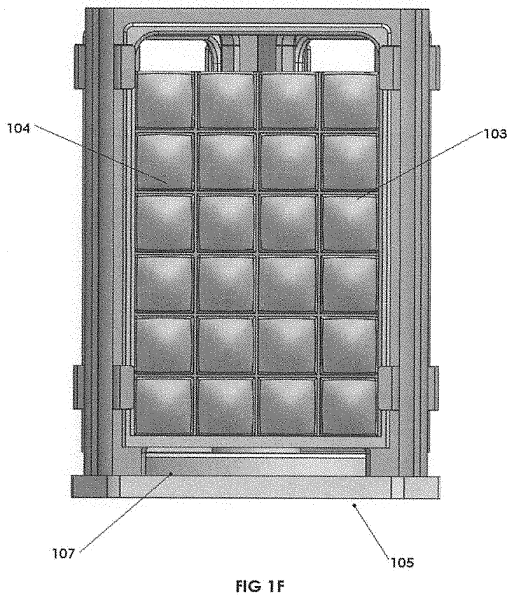

Referring now in detail to the drawings wherein like reference numerals identify similar or like components throughout the several views, various embodiments of the malaria control device are illustrated. Each of the embodiments embodies the concept of providing a nutritious source and attracting mosquitoes with odor, temperature, sound and/or light. In general, the delivery device for the food source will have an outer housing and an internal food source presented in either synthetic membrane cartridges, a membrane or a refill fluid chamber with a synthetic membrane over the cartridge or chamber for mosquitoes to land. The mosquito attraction can be achieved via one or more of light, odor, temperature, color and/or sound within the housing. Note for convenience of discussion, the devices and methods are described in conjunction with malaria reduction, however, it should be understood, that this is provided by way of example, as the devices of FIGS. 1A-9C described herein are fully applicable to other mosquito borne/transmitted diseases such as those listed herein by way of example.

With initial reference to FIGS. 1A-1F, a first embodiment of the malaria reducing device of the present invention is illustrated. The device is designated generally by reference numeral 100 and is in the form of a pole. The device 100 includes an internal cartridge 104 supporting a nutritious source 102 (also referred to herein as a food source) that is formed in an array of pods 103 which can have various shapes, and in the illustrated embodiment has multiple square patterns 103. The rectangular structures 103, e.g., squares, form synthetic sections of the nutritious source 102. That is, the pods 103 are formed by the viscous synthetic fluid and are shaped to prevent the fluid from being all at the bottom of the cartridge 104, keeping it the same throughout the cartridge 104. The pods 103 by way of example can be one inch square pods, although other dimensions as well as shapes other than squares are also contemplated. (Note throughout the various embodiments, only some of the pods are labeled for clarity). The pods for the nutritious source 102 could also include different shapes or patterns, and different sizes, within the device. The pods can be of the form of sections of the synthetic blood which is viscous to be in a gel like form. Alternatively, the pods can be in the form of puncturable containers or holders which contain the synthetic blood media therein.

The cartridge 104 supporting the nutritious source 102 in the illustrated embodiment contains three rectangular shaped panels 104A, 104B, 104C (collectively the cartridge 104) arranged in a triangular configuration, although a different number of panels supporting the pods 103 can be provided. Additionally, the panels 104 can be arranged in other configurations, e.g., rectangular. Each panel 104 supports multiple pods 103.

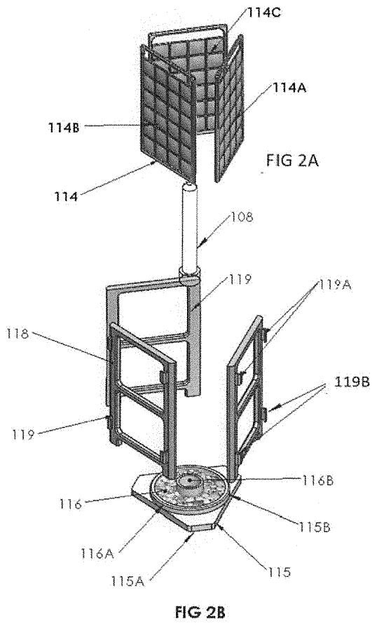

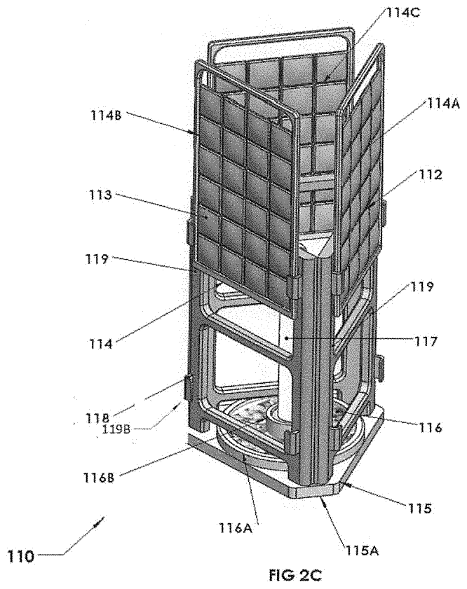

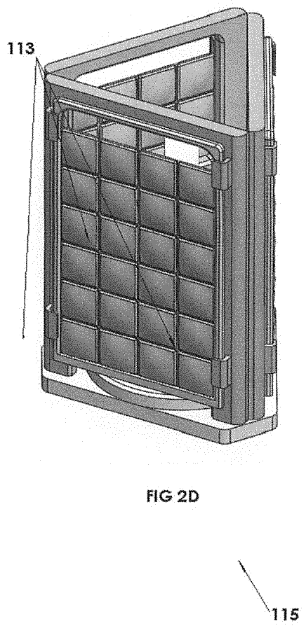

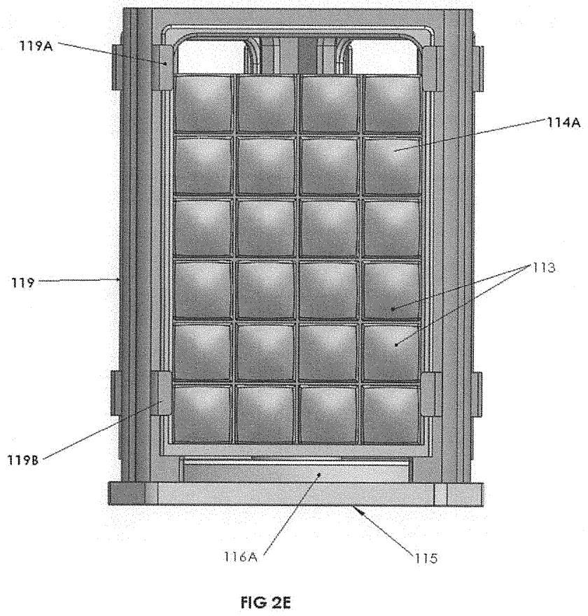

The panels 104A, 104B, 104C are mounted on a support structure 109. They can be held in place by tabs 109A in the same manner as device 110 of FIG. 2B described below.

The pods 103 with the nutritious source 102 have a synthetic skin or organic material thereover through which the mosquitoes can access the synthetic blood. The cartridge 104 is attached to a base 105 and can have odor source 107 on the base 105 or around the internal food source 102. The base 105 can help balance the device. The base 105 can be circular as shown in FIG. 1C. The base 105 can also be other shapes such as a triangular-like shape of FIG. 2B discussed in detail below. The support structure 109 can be welded, clipped or attached to the base 105 in other ways.

The housing 106 forms an outer housing and is placed over the cartridge panels 104A, 104B, 104C and nutritious source 102 and can be made of aluminum or plastic for example and is designed to prevent anything other than mosquitoes having access to the food source 102, i.e. preventing entry of vertebrates. This can be achieved by limiting the size of the openings 106A in the housing 106 to only allow mosquitoes to enter the outer housing 106 to access the synthetic media 102, thus providing a way to protect the food source cartridges 104. In the embodiment of FIG. 1B, the openings 106A are elongated and an oval-like shape, extending longitudinally with respect to the longitudinal axis of the housing 106. However, it should be understood that other orientations, shapes, and/or number of openings/slots are also contemplated. The housing 106 (and other housings disclosed herein) can also be decorative to provide a desired appearance of the device. Housing 106 is cylindrical in configuration but could also be other shapes. The device 100 can optionally include internal lighting 108 to assist with maintaining a warm temperature, such as 37 degrees C. for example, around or at the food source 102. FIG. 1C shows the outer housing (cover) 106 prior to placement over the synthetic media and FIG. 1B shows the device with the housing 106 placed thereover to cover the cartridge 104. The lighting and therefore temperature around the food source can be battery operated or any other viable method to support geographic locations where access to power is limited.

The food source can be held in cartridges 104 by various ways. In one embodiment, the food source is held in liquid suspension within the pockets of the cartridge 104. One or more of the cartridge panels 104A, 104B, 104C can be replaceable, when depleted, either individually or collectively with another cartridge containing the food source. Thus, in the embodiment of FIG. 1A, the internal food source can have three replaceable cartridges, held in a triangular arrangement as noted above. In other embodiments, a fewer or greater number of cartridges can be held by the support structure and they can be held in configurations other than triangular. The panels can be of various dimensions. In one embodiment, by way of example, each of the replaceable cartridges (panels) could have an initial dimension as 8 inches high×4.5 inches wide and 0.375 inches thick, depending on the fluid and material. Other dimensions are also contemplated. In a non-replaceable embodiment or in an embodiment where all panels are removed together, the cartridge panels can be provided as a single unit.

An attractive source (also referred to herein as the attractant) is positioned on the base 105 which could be in the forms of rocks, pods, or other structure generating an odor to attract mosquitoes. Thus, the attractive source is designed to emit an odor. As noted above, the attractant could also include a color, sound and/or light in addition or in lieu of the odor generating attractant. The attractant could also be positioned in other areas of the device and is not limited to placement at the base.

In summary, the cartridge 104, i.e., the cartridge panels 104A, 104B, 104C, are slid into the holding (support) structure (fixture) 109 which is attached to the base 105. The housing 106 is placed over the cartridge 104 and mounted to the base 105 and in some embodiments the housing 106 is secured thereto by clips, latch, or other methods. The device 100 is portable and can be placed at strategic locations to attract and sterilize mosquitoes as described herein.

FIGS. 2A-2E illustrate an alternate embodiment of the device of the present invention, designated by reference numeral 110. The device 110, like device 100, is also in the form of a self-standing elongated pole with a height (or length) greater than a width. Device 110 differs from the device 100 of FIG. 1A in the configuration of the base 115. Base 115 is somewhat triangular shaped except the vertices form flat sides so that the base 115 has six sides—each short side 115A joining two adjacent long sides 115B. The holding structure 118 has three supports 119 with retention tabs 119a on top (or proximal) and retention tabs 119b on the bottom (distal) portions forming slots to slidingly receive the cartridge panels 104A, 104B, 104C of the internal cartridge 114. The internal cartridge 114, like cartridge 104 of FIG. 1A, contains the nutritious (food) source 112, which is the same as nutritious source 102, contained as or supported in pods 113, like the pods of FIG. 1A. The cartridge panels 104A, 104B, 104C are arranged in a triangular arrangement as in FIG. 1A and slide within the supporting (holding) structure (frame) 118, retained by the retention tabs 119A, 119B. The holding structure can be attached to the base by various ways such as welding, clipping, fastening etc. Three frames 119 of the holding structure 118 are shown, corresponding to the number of cartridge panels 114, and the frames 119 can be arranged in a triangular configuration as shown, although other configurations are also contemplated.

The attractive source 116 is mounted on a circular support 116A which is mounted to the base 115. Warming light 117 can be supported by the structure 116A to warm the food source. For example, it can be mounted within opening 116B of supporting 116A. In some embodiments, the light source can also be used to attract the mosquitoes. (Note such light source can be used in any of the embodiments disclosed herein and mounted/supported in a similar fashion). In all other respects, the portable device 110 is the same as device 110 and functions in the same way so the discussion of the features and function of device 100 is fully applicable to the device 110.

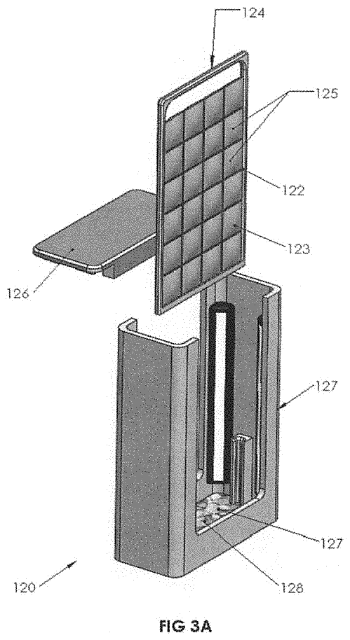

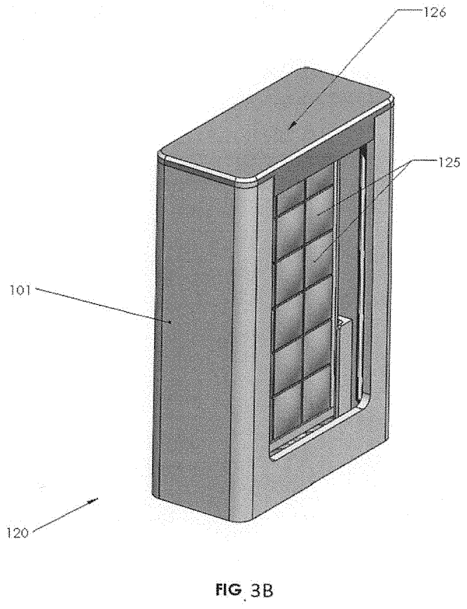

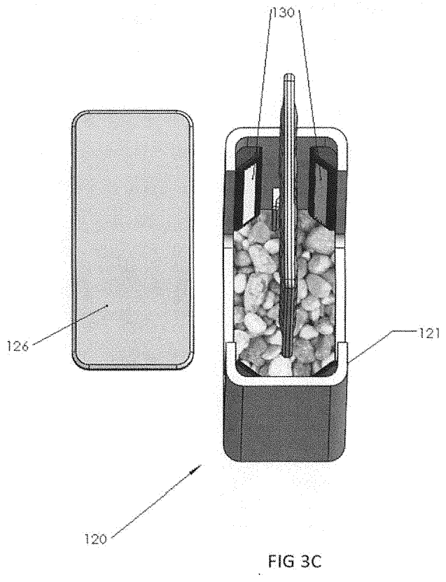

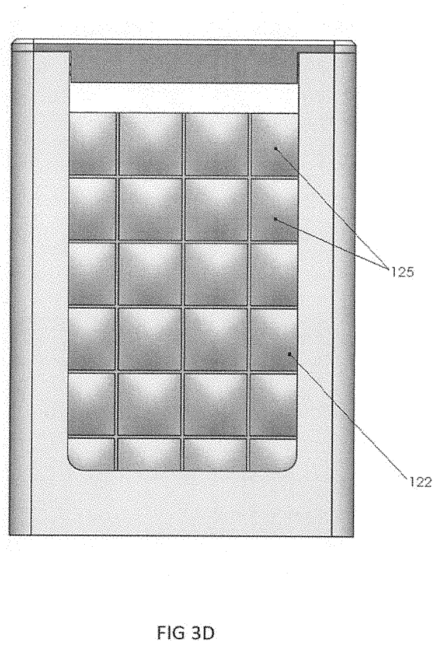

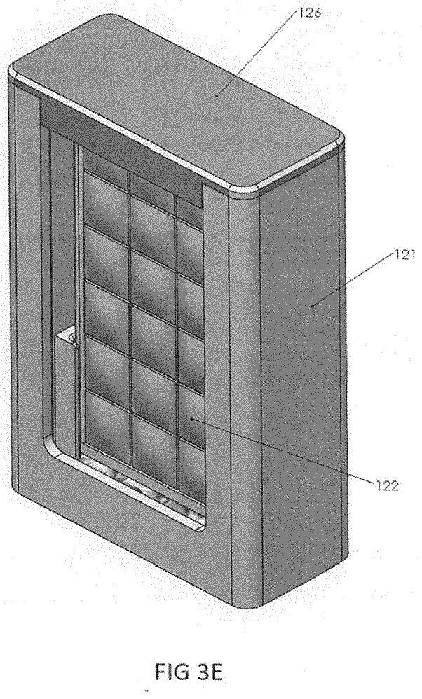

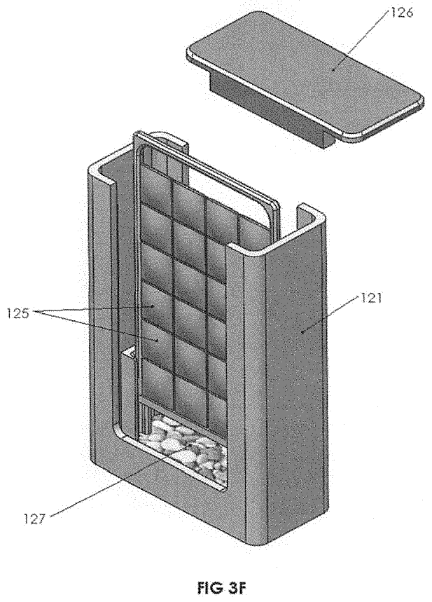

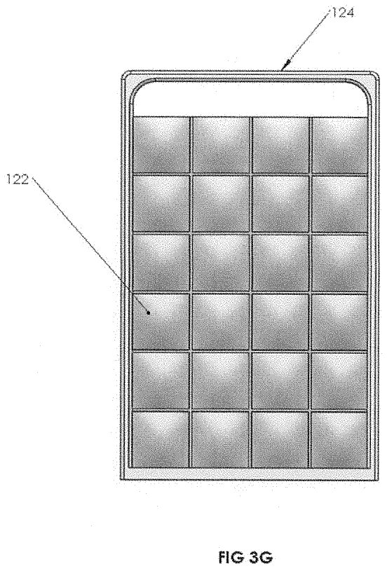

An alternate embodiment of the malaria reducing device is illustrated in FIGS. 3A-3G. In this embodiment, the device is rectangular or box shaped. It also contains a single cartridge, although alternatively it could contain multiple cartridges.

More specifically, device 120 has an internal cartridge 122 and a housing 121 forming an outer housing which has a holding fixture for the cartridge 122 and a top cover 126. Similar to the device 100 of FIG. 1A, device 120 has an internal food source 123 held in cartridge 122 in the form of square pods 125 which can be covered by a synthetic media as described above. The device 120 contains a single cartridge 122 which is slidingly received within inner tabs or alternatively, within inner grooves, within outer housing 121. The cartridge 122 (like the other cartridges disclosed herein) can be replaceable and can include a handle 124 (like the other cartridges disclosed herein) to facilitate top loading sliding insertion into the outer housing 121 and removal from the outer housing 121. After placement of the cartridge 122 into the housing 121, the top cover 126 is placed over the housing 121, e.g., snapped onto the top of the housing 121, to close the housing 121. If it's desired to replace the inner cartridge 122, the top cover 126 is removed to access the cartridge 122 and the cartridge 122 is slid out from housing 121. Nutritious food source 123 in the illustrated embodiment is supported in multiple square pods 125 similar to device 100 of FIG. 1A, although other dimensions and shapes, as well as other media containing structure are contemplated. The pods 125 can include synthetic skin or organic material thereover forming synthetic pockets through which the mosquitoes can bite through to access the media in the pods.

After placement of the cartridge 124 containing the media into housing 121, the cover 126 is placed over the housing 121. In this embodiment, the device 120 is rectangular shaped. A mosquito attractive source 127 (as described above) is placed at the base 128 of the housing 121. A light source can also be included in the outer housing 121 to warm the nutrition source 102 and/or attract the mosquitoes. The device 120, like devices 100 and 110, is portable and can be placed at strategic locations to attract and sterilize mosquitoes as described herein.

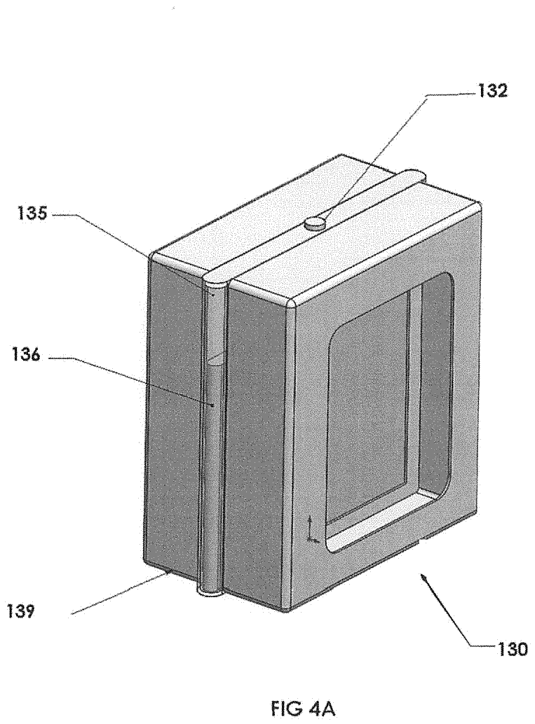

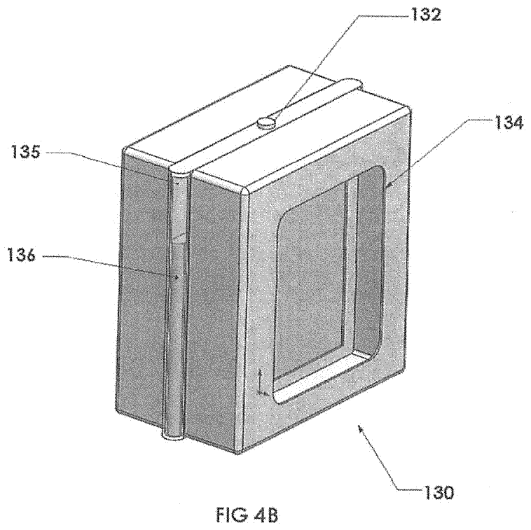

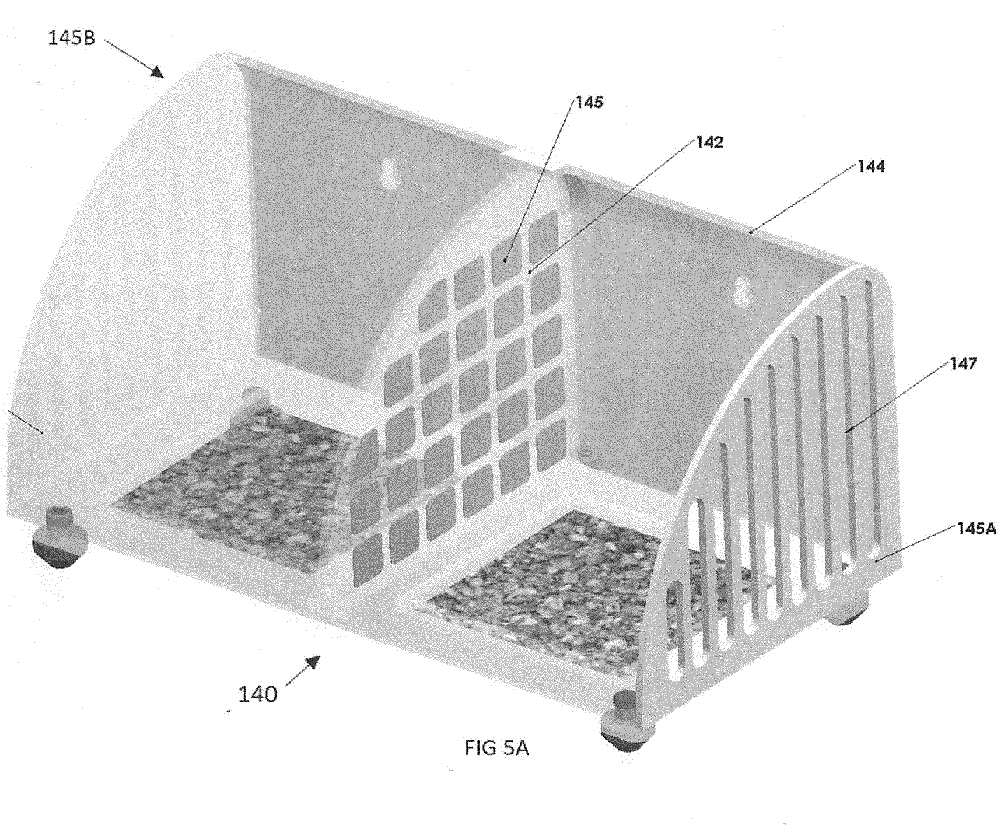

FIGS. 4A and 4B are perspective views of an alternate embodiment of the device having a fluid filling port 132 at the top of the device 130. That is, this version does not use a cartridge to support pods containing the media, but instead is fluid operated and utilizes refill bottles for the synthetic media (food/nutrition source). The fluid is inserted into a chamber 135 in the outer housing 134. The chamber can be made of plastic or other materials. Membrane 136, preferably configured to mimic human skin, is provided on the chamber 135. Side openings 139 in the housing 134 enable mosquito access to the food source. Front openings such as opening 138 and rear openings can also be provided. A battery or other power source can power a pump in instances where it is desired for the fluid to be circulated/agitated. The membrane 136 can include a transparent section to form a window to check the fluid level or other ways to indicate liquid levels. The housing 134, or portions thereof, can be transparent. The base can act as a reservoir in some embodiments for fluid in case fluid needs to circulate. Attractants such as those discussed above can be provided in the device 130 to attract the mosquitoes. Various dimensions are contemplated. In one embodiment, by way of example, the device 130 is rectangular boxed shape with a height of 10 inches, a width of 5 inches and a depth of 8 inches.

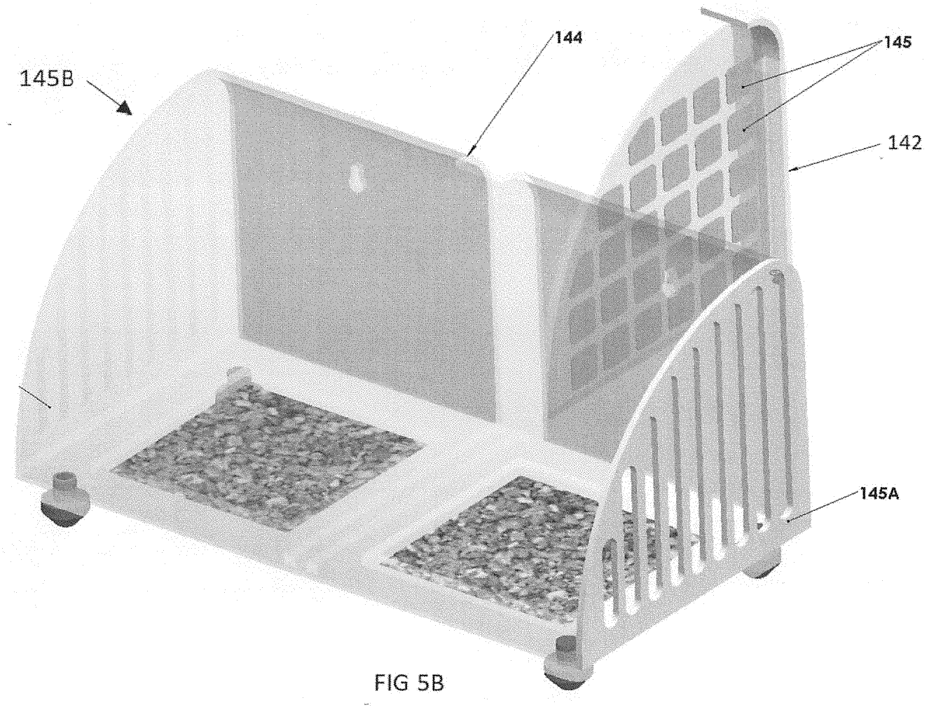

FIGS. 5A and 5B are perspective views of an alternate embodiment of the device of the present invention configured for table top placement/location (referred to as a “table top version”) due to its more horizontal orientation. The device 140 has a food source 144 provided in cartridge 142, for example in pods 145 supported on the panel of the cartridge 142 as in the panel 104A of FIG. 1A discussed above, which is slid into housing 144 of device 140. As shown, the cartridge 142 is slid in through a rear opening in the housing 144 in a direction transverse to a longitudinal axis of the device 140. The cartridge 142 can be removable and replaceable with another cartridge 142 containing a food source when the food source of cartridge 142 is depleted. FIG. 5B shows the cartridge 142 removed from the housing 144; FIG. 5A shows the cartridge 142 contained within the housing 144. The side panels 145a, 145b have openings 147 dimensioned to allow entry of the mosquitoes while small enough to deny access other than mosquitos. The openings 147 are shown as elongated slots but other configurations and dimensions are also contemplated. The device can include a single cartridge or multiple cartridges.

The device 140 can have an odor or other attractant at the base as in the foregoing embodiments. The device can have a light source inside of the protective housing 144 for the reasons discussed above.

Various dimensions of device 140 are contemplated. In one embodiment, by way of example, the device has a height of 9 inches, a width of 9 inches and a length of 20 inches. Such dimensions provide a portable device that be mounted on a table top or other surface.

In an alternate embodiment of the present invention, the synthetic media is held in or covered by a hydrogel membrane which mimics skin. The hydrogel membrane protects and preserves the synthetic blood and is self-sealing so after penetration by the mosquito to access the synthetic blood maintains the seal. This hydrogel material enables multiple feedings without the risk of leaks of the synthetic blood. In some embodiments, the hydrogel membrane is porous with pores by way of example being 1 mm in size. Other sizes are also contemplated. The presence or size of the pores is dependent on the viscosity of the synthetic blood. In other embodiments, the hydrogel membrane does not have such pores. The hydrogel material has several advantages including self-closing, permeable, and transparent. It is also about 90% water. Note that alternatively a membrane of silicone or another material can be utilized.

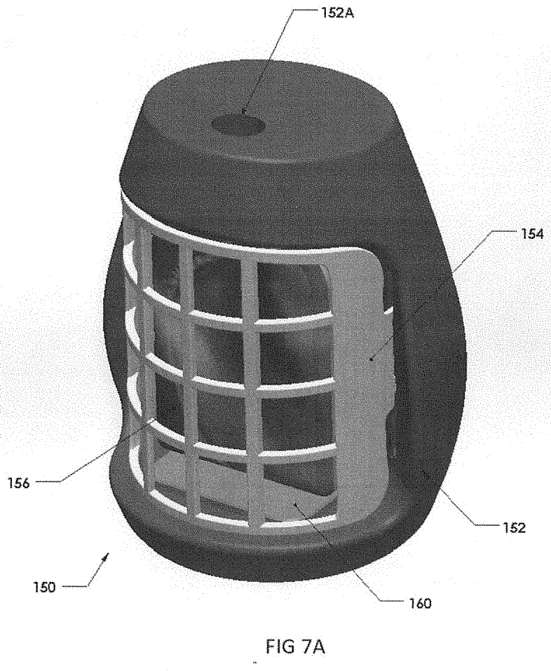

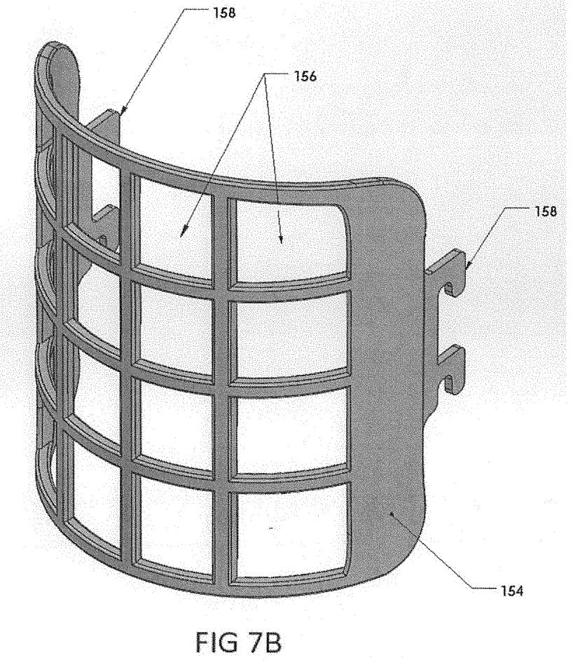

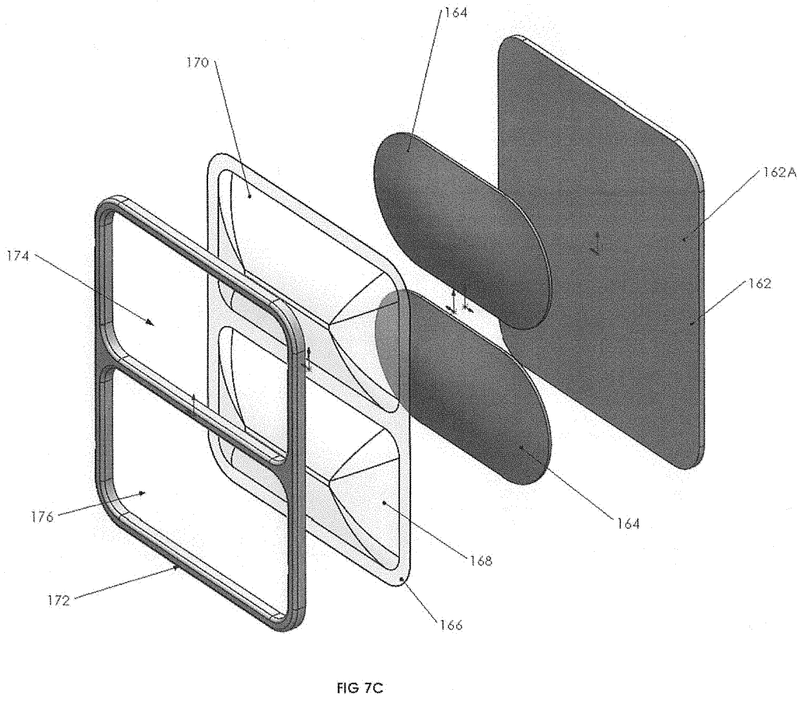

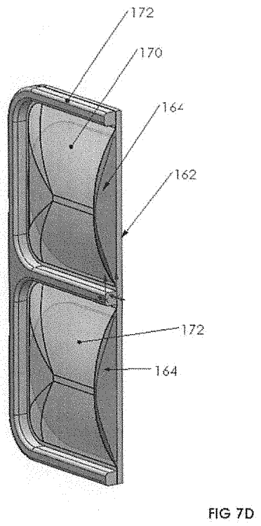

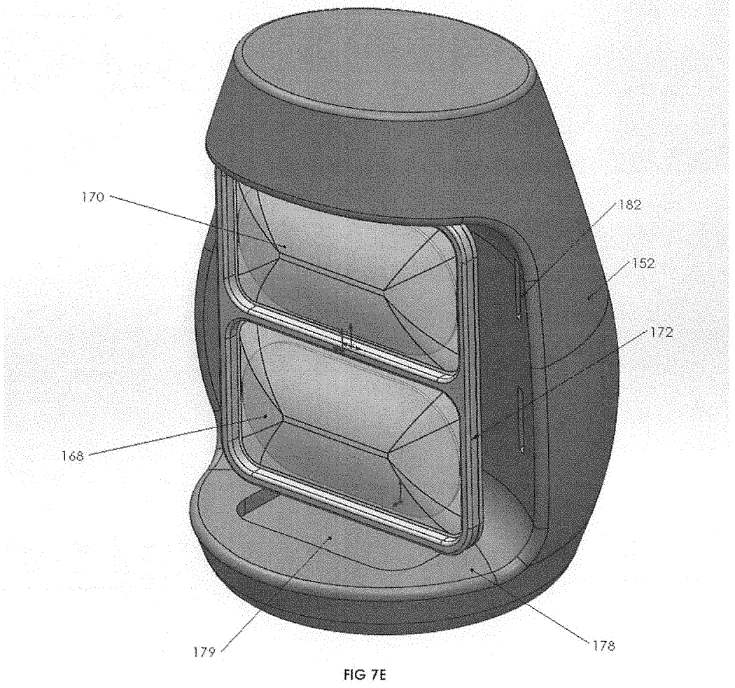

Turning now to FIGS. 7A-9C, three embodiments of the device containing the hydrogel membrane (or alternatively a silicone or other membrane) are disclosed. The devices are in the shape of a kerosene lamps, although other shapes are also contemplated.

In the embodiment of FIGS. 7A-7E, device 150 has an outer housing 152 which includes a replaceable front cover 154. Contained within the outer housing 152 is the synthetic blood media (like the synthetic media described above) which form two pods 164 by way of example. The synthetic blood has sufficient viscosity to be in gel like form so it can be placed within pockets of the hydrogel membrane 166. Alternatively, the synthetic blood can be held in pods in the form of containers or holders placed in the pockets of the membrane 166. A hydrogel membrane 166 is placed over the two pods 164, with regions 170 and 168 each overlying (covering) a pod 164 to cover it on one side. Note the pods 164 are arranged in an array to form a top and bottom pod. However, the pods can be arranged in other orientations and can be other shapes and sizes. Additionally, the number of pods can be greater than 2 or a single pod can be provided, and other shapes can be provided. In any event, the hydrogel membrane 166 is configured to overlie the pods and in some embodiments can have pocket(s) corresponding to the number of pods 164. The pods 164 (as well as the other pods disclosed herein), if in the form of containers are made of a material to retain the synthetic blood therein, and are also penetrable by the mosquitoes to access the synthetic blood. The pods 164, (as well as the other pods disclosed herein), if of the form placed directly in the pocket (without containers), are accessed as soon as the hydrogel membrane is penetrated.

With reference to FIG. 7C, a front frame 172 has openings 174, 176 to receive respective regions 170, 168 of hydrogel membrane 166. A rear back or panel 162 opposes frame 172 and has a front facing surface 162a. The hydrogel membrane 166 and pods 164 can thereby be considered as sandwiched between the front frame 172 and rear opposing panel 162. This assembly, which can be considered an internal cartridge, is positioned within the outer housing 152 as shown in FIG. 7E. The cartridge can be supported on base 178 and is shown supported in a vertical position, although other positions, including angled positions are also contemplated. Recess or pocket 179 at the bottom of base 178 can receive a mosquito attractant as in the other embodiments discussed above. In an alternate embodiment, the attractant such as an odor source, e.g., CO2, can be positioned within a pod, membrane or other containing device, and can be positioned between the hydrogel membrane and the pod or in areas other than the base. Thus, the odor generating pod adjacent the hydrogel membrane and pods containing the synthetic blood media function to attract the mosquitoes. The housing 152 can optionally include a top opening 152A for attachment of a hook or other device to hang the device 150. A light source such as those described above can optionally be provided to warm the food and in some embodiments to attract the mosquitoes.

The housing 152 includes a front cover 154 which has openings dimensioned to allow entry of mosquitoes but preventing entry of vertebrates. Hooks of tabs 168 engage slots 182 to secure the front cover 154 to the housing 152. The front cover 154 is removable so the cartridge can be replaced with another cartridge having a new supply of synthetic media (nutritious source) covered by a hydrogel membrane. The replacement cartridge can be in the form of the hydrogel membrane, synthetic blood, front frame and opposing rear panel as in FIG. 7C.

Device 150 functions in the same manner as described above in that the mosquitoes can enter through openings in the outer housing to access the food source which causes sterilization to reduce proliferation of eggs.

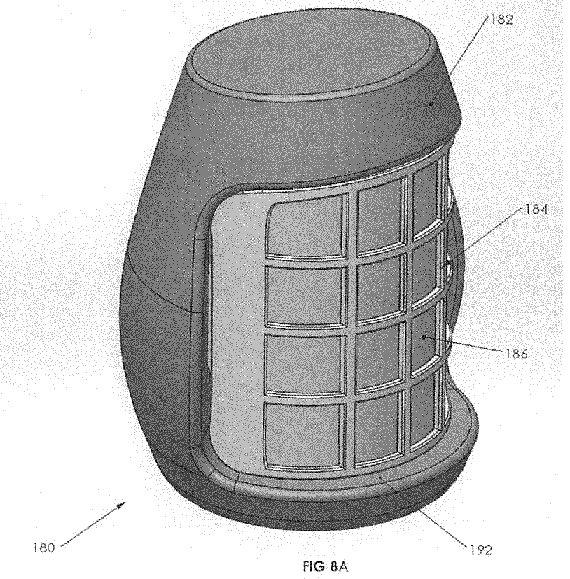

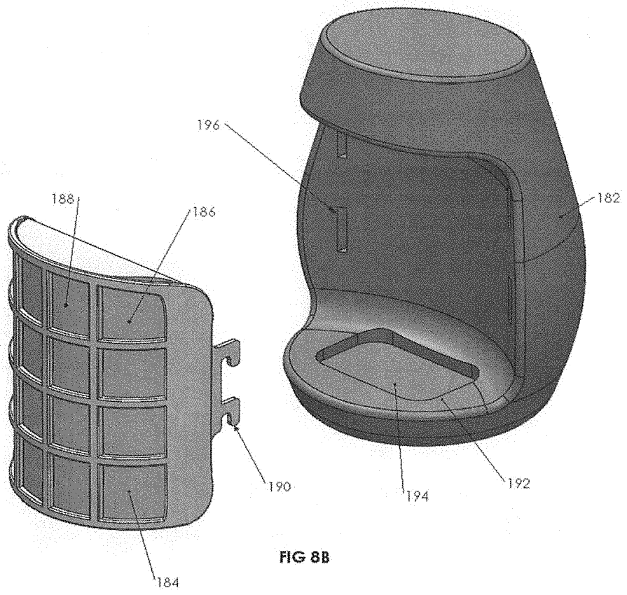

In the embodiment of FIGS. 8A and 8B, the device, designated generally by reference numeral 180, is in the shape of the device 150 of FIG. 7A. Device 180 differs from device 150 in that the hydrogel membrane 186 and food source are attached to the front cover 184 of housing 182. In some embodiments the hydrogel membrane (film) is heat sealed to the front cover 184, although other ways of attachment are also contemplated. The hydrogel membrane 186 covers the synthetic media (the pods) and is adjacent the openings 188 in the front cover 184. The front cover 184 has mounting tabs 190 mounted within slots 196 in housing 182. Mosquitoes access the hydrogel membrane 186 though openings 188 in cover 184 to access the synthetic blood. The food source, when depleted, can be replaced by removing the front cover 184 (and attached membrane and synthetic media pods) from the housing 182 and replacing it with another front cover having the hydrogel membrane and synthetic media pods in the same configuration as in FIG. 8B.

Recess or pocket 194 at the bottom of base 192 can receive a mosquito attractant as in the other embodiments discussed above or the attractant can be in other regions, e.g., adjacent the membrane. The housing 192 can optionally include a top opening for hanging the device 180. A light source such as those described above can optionally be provided to warm the food and in some embodiments to attract the mosquitoes.

In an alternate embodiment, the hydrogel membrane fully covers the synthetic blood media by fully encapsulating the media therein in a bag like manner. The hydrogel membrane can be mounted to a support within the outer housing or can be provided with a hook or other mechanism for hanging within the outer housing.

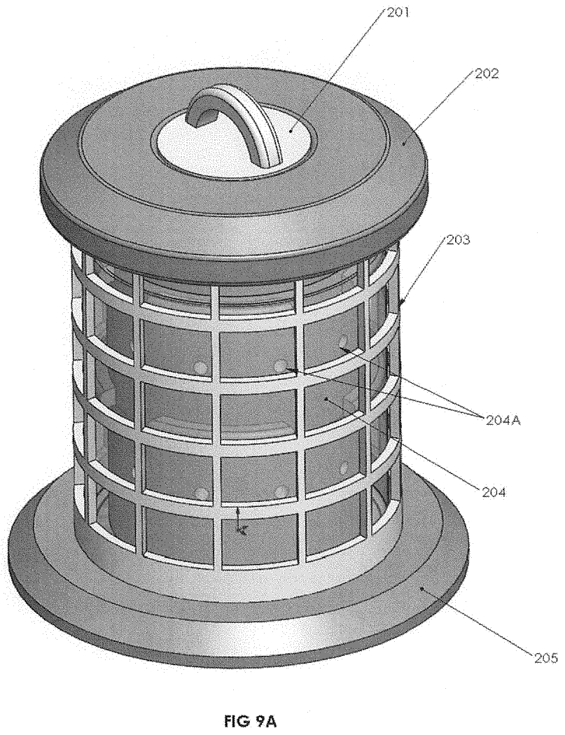

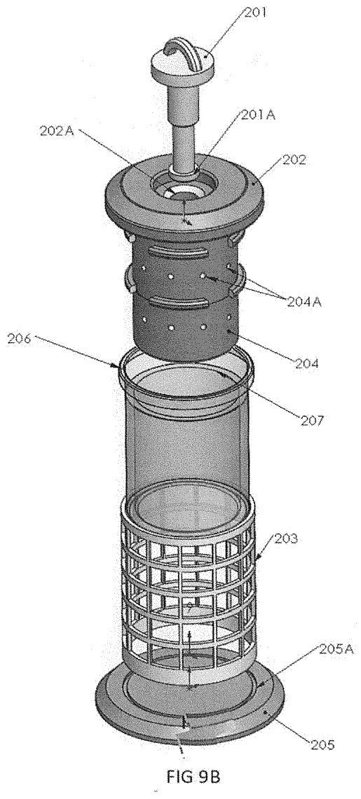

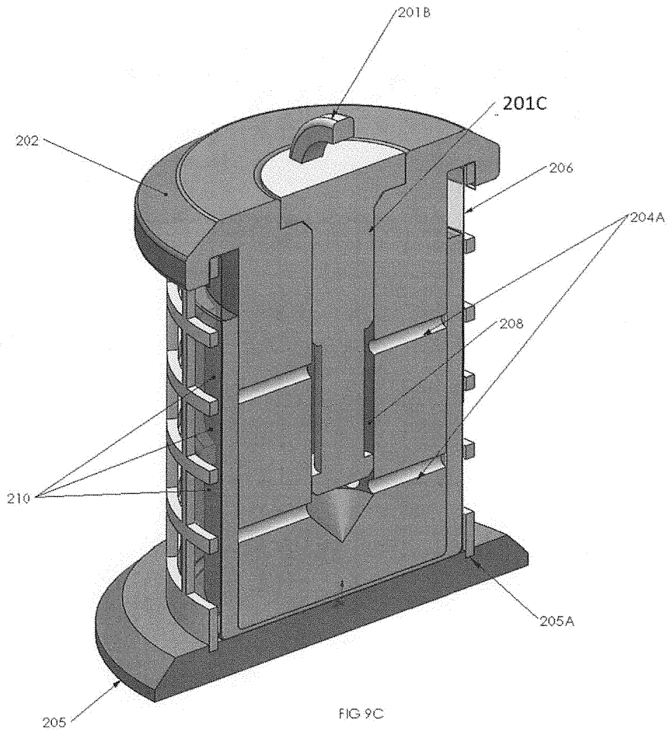

FIGS. 9A-9C illustrate an embodiment wherein the hydrogel membrane encapsulates the synthetic blood media. The device includes an outer housing or cover 203 with openings 210. The fluid, e.g. synthetic blood, 207 is contained within the hydrogel membrane 206. The hydrogel membrane 206 is positioned within the outer housing 203 and forms an open balloon like (or condom-like) shape so that synthetic blood media is positioned within its opening Outer housing 203 is attached to base 205 and extends upwardly therefrom. The outer housing 203 can be seated within a groove 205A in base 205. (Note the membrane is transparent so it is not shown in FIG. 9A). The upper end or lip of the membrane 206 is wrapped around the top (or a rim) of the outer housing 203 to hold the membrane 206.

In the device of FIGS. 9A-9C, rather than the membrane remaining within the confines of outer housing as in device 150 and 180, the hydrogel membrane 206 protrudes out through the openings 210 in the outer housing 203. Center piece 204 forms a first plunger and has a central opening 208 extending longitudinally therethrough. Central opening 208 has a top entry 202A. Side holes 204A communicate with the central opening 208. Two rows of longitudinally spaced side holes 204a are shown, however, a fewer or greater number of side holes and rows are also contemplated. Center piece 204 can include a series of outer ribs as shown in FIG. 9B to limit lateral movement of the center piece 204 within housing 203. Center piece 204 has a top region or cover 202 which can be a separate component or integral with center piece 204. Plunger 201 has a handle 201B and a bottom ring 201A at the bottom of rod 201c dimensioned to tightly fit within central opening 208 of center piece 204 similar to an O-ring seal. Plunger 201 forms a secondary plunger to force the hydrogel membrane 206 to further protrude from the outer housing 203.

In use, with the hydrogel membrane 206 positioned within the outer housing 203 and containing the synthetic blood media therein, the center piece 204 is pressed downwardly toward the base 205 into the opening in the membrane 206 to compress the media which applies a force to the inner wall of the membrane 206 to force the membrane 206 out through the openings 210 in the outer housing 203. If additional protrusion (bulging) of the membrane 206 is desired, plunger 201 is depressed, e.g., pressed downwardly toward the base 205. This pushes air out through the side openings 204A against the inner wall of the membrane 206, thereby forcing the membrane 206 to further bulge (protrude) outwardly through the openings 210 in the outer housing 203. To remove the membrane 206 for replacement with another membrane with a fresh food source, the center piece (first plunger) 204 and second plunger 201 are retracted, relieving the pressure on the membrane 206 so the membrane 206 can return to its non-bulging position within the confines of the cover 203. The plunger 201 and center piece 204 are removed to access and remove the membrane 206 for replacement with another membrane 206 containing the food source which is attached to the outer housing 203 as explained above.

The present invention includes at least four versions of the device: 1) a pole fixture designed for outdoor or indoor use; 2) a table top fixture designed for indoor or outdoor use for placement on top of furniture or other support; 3) a hanging device for indoor or outdoor use; and 3) a large scale commercial pole fixture designed for outdoor use. For outdoor use, the outer housing can be altered to support the environment and resist weather, but would have the food source, optional light etc. as described above.

The device when configured as a human pole can be of various heights. In some embodiments, it is human average height or mosquito optimum flying height.

The devices can have a “media” bath at the base to provide a location for the female to lay eggs. In some embodiments, the media can be placed in channels to mimic human veins (and circulate).

The cartridges disclosed herein are removable or replaceable with another cartridge (or multiple cartridges) each containing a food source. However, it is also contemplated that the cartridges cannot be removable and are permanently positioned within the housing. The cartridges can be shipped as separate units or shipped already supported by the housing.

The devices disclosed herein can have transparent sections to enable visualization of the status of the depletion of the food source so more food can be added to the device.

Although the devices described herein are designed to address malaria, the device can be utilized to combat other diseases where the mosquito is the sole vector or where the vector behavior is close to that of the anopheles mosquito. As a potential add-on to treated mosquito nets, the device has the potential to increase the efficacy of the nets and thus help with the overall fight against Malaria or other mosquito-borne diseases.

While the above description contains many specifics, those specifics should not be construed as limitations on the scope of the disclosure, but merely as exemplifications of preferred embodiments thereof. Those skilled in the art will envision many other possible variations that are within the scope and spirit of the disclosure as defined by the claims appended hereto.

What is claimed is:

1. A device for reducing cases of mosquito transmitted illnesses in humans comprising:
a) an inner member containing a food source, the food source causing sterilization of female mosquitoes;
b) an outer housing, the inner member positioned within the outer housing, the outer housing having at least one opening; and
c) an attractant within the outer housing to attract mosquitoes to the food source.

2. The device of claim 1, wherein the inner member is removable and replaceable with another inner member having a food source.

3. The device of claim 1, wherein the at least one opening is dimensioned for entry of mosquitoes to access the food source contained by the inner member.

4. The device of claim 1, wherein the inner member protrudes through the at least one opening.

5. The device of claim 4, further comprising a plunger movable to cause the inner member to protrude through the at least one opening.

6. The device of claim 1, wherein the inner member contains at least one panel, the at least one panel containing individual pods of the food source arranged in an array.

7. The device of claim 1, further comprising a light source positioned within the outer housing to warm the food source.

8. The device of claim 1, wherein the attractant emits an odor to attract mosquitoes and contains CO2 and sulfur.

9. The device of claim 1, wherein the food source is synthetic blood.

10. The device of claim 1, further comprising a self-sealing hydrogel membrane positioned over the food source to contain the food source.

11. The device of claim 10, wherein the outer housing includes a removable cover and the hydrogel membrane is attached to the cover.

12. The device of claim 1, wherein the inner member is transparent so a level of food source contained within the inner member can be checked.

13. A device for reducing cases of mosquito transmitted illnesses comprising a support and a synthetic blood media supported by the support, the synthetic blood media providing a nutrition source to sterilize female mosquitoes.

14. The device of claim 13, wherein the synthetic blood media satiates the female mosquitoes.

15. The device of claim 13, wherein the support comprises a hydrogel membrane, the hydrogel membrane being self-sealing.

16. The device of claim 15, wherein the hydrogel membrane is removably mounted to the device and replaceable with another hydrogel membrane covering a new supply of the synthetic blood media.

17. The device of claim 13, further comprising an attractant to attract the mosquitoes, wherein the attractant is an odor generator containing CO2 and sulfur.

18. A method for reducing a portion of a population of the mosquitoes to reduce cases of mosquito transmitted illnesses, the method comprising providing a synthetic blood media supported within a housing and a mosquito attractant, the synthetic blood media providing a food source to reduce egg proliferation of female mosquitoes feeding on the synthetic media.

19. The method of claim 18, wherein the synthetic blood media is of a composition that provides the mosquitoes with a satiated feeling to reduce additional feedings.

20. The method of claim 18, wherein the method reduces the cases of the mosquito transmitted illness of one or more of malaria, dengue fever and Zika virus.
